(19) United States
(12) Patent Application Publication
(10) Pub. No.: US 2005/0132344 A1
(43) Pub. Date: Jun. 16, 2005

(54) Method of compilation

(76) Inventors: Martin Vorbach, Munich (DE); Markus Weinhardt, Munich (DE); Jaoa Cardoso, Munich (DE)

Correspondence Address: KENYON & KENYON, ONE BROADWAY, NEW YORK, NY, 10004, US

(21) Appl. No.: 10/501,903

(22) PCT Filed: Jan. 20, 2003
(86) PCT No.: PCT/EP03/00624

(30) Foreign Application Priority Data
Jan. 18, 2002 (EP) 02001331.4
Dec. 6, 2002 (EP) 02027277.9

(51) Int. Cl. G06F 9/45

(52) U.S. Cl. 717/151; 717/162

(57) ABSTRACT

A method for partitioning large computer programs and or algorithms at least part of which is to be executed by an array of reconfigurable units such as ALUS, comprising the steps of defining a maximum allowable size to be mapped onto the array, partitioning the program such that its separate parts minimize the overall execution time and providing a mapping onto the array not exceeding the maximum allowable size is described.

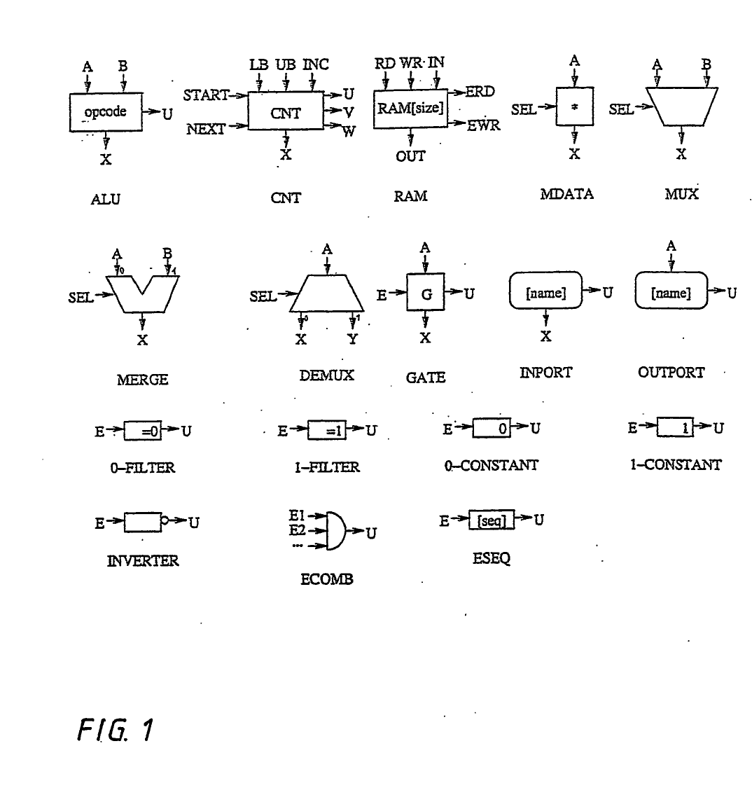

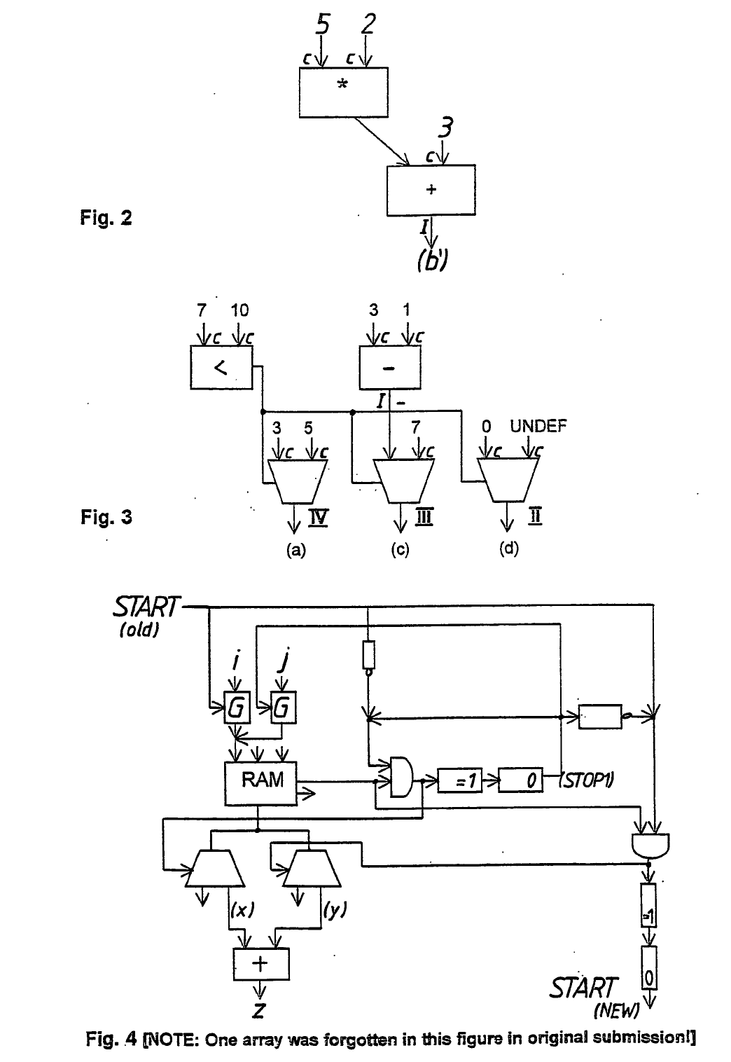

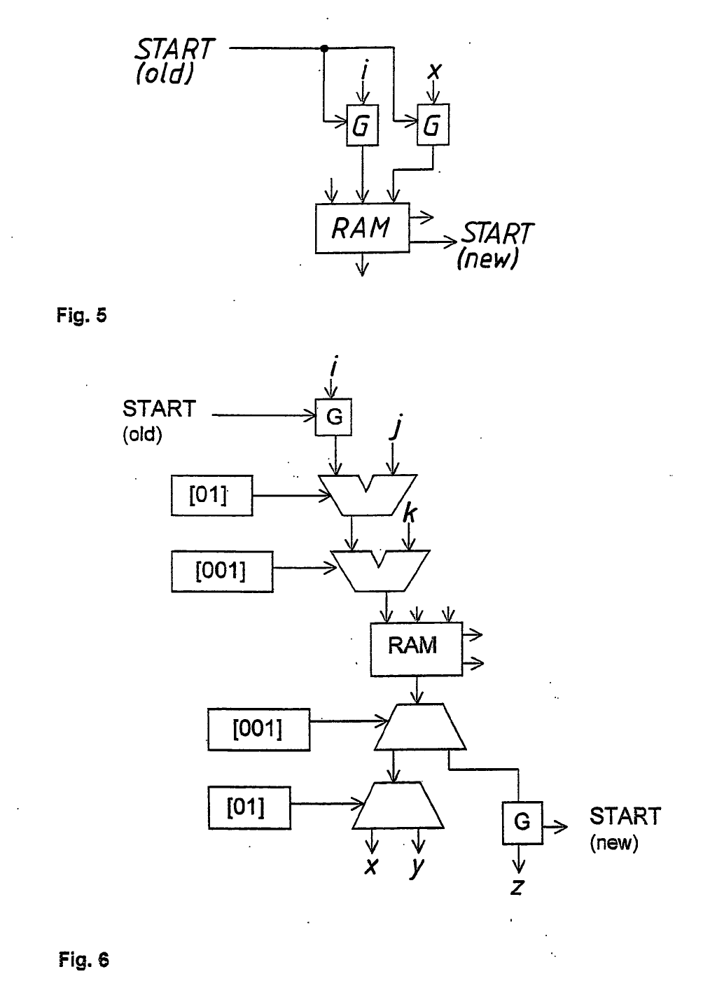

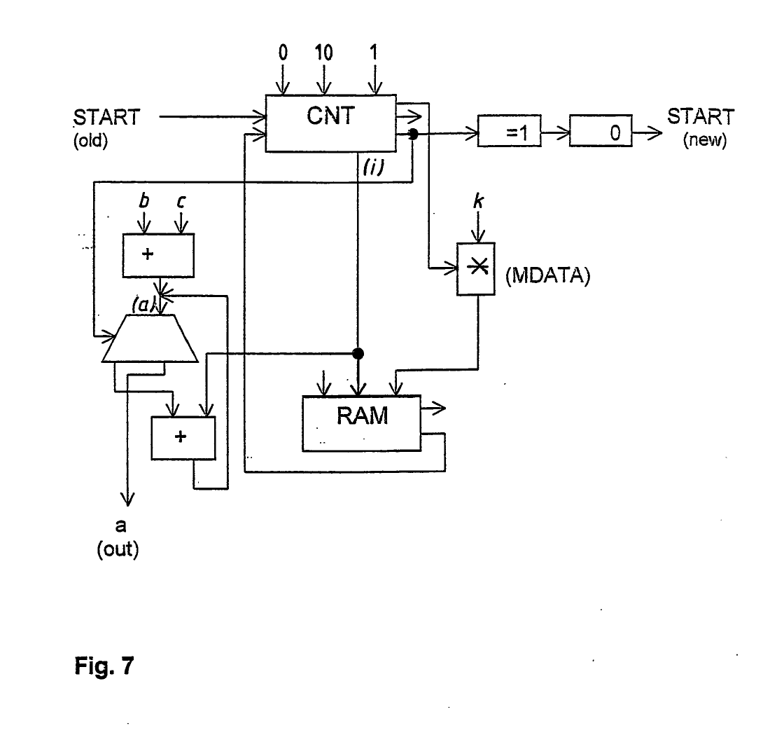

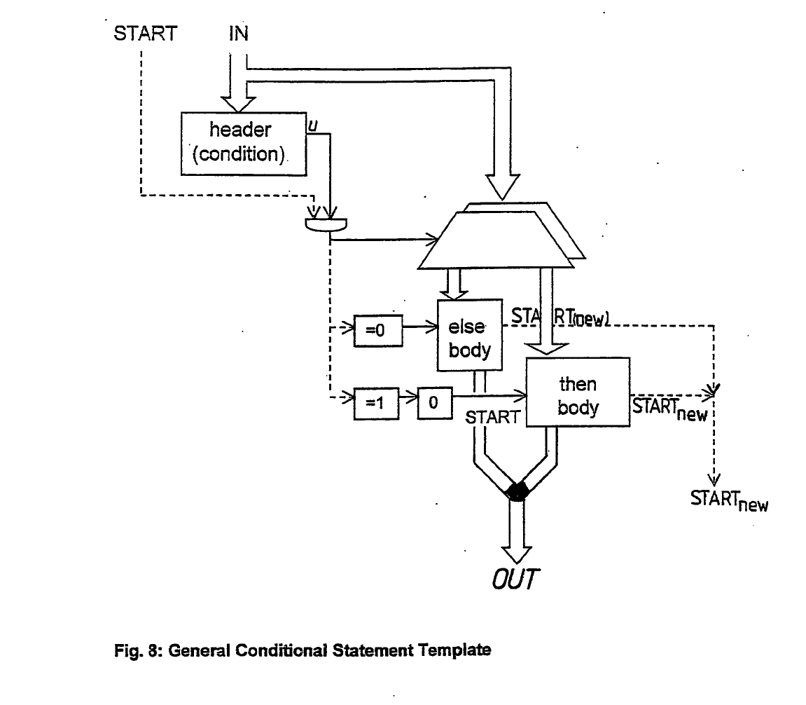

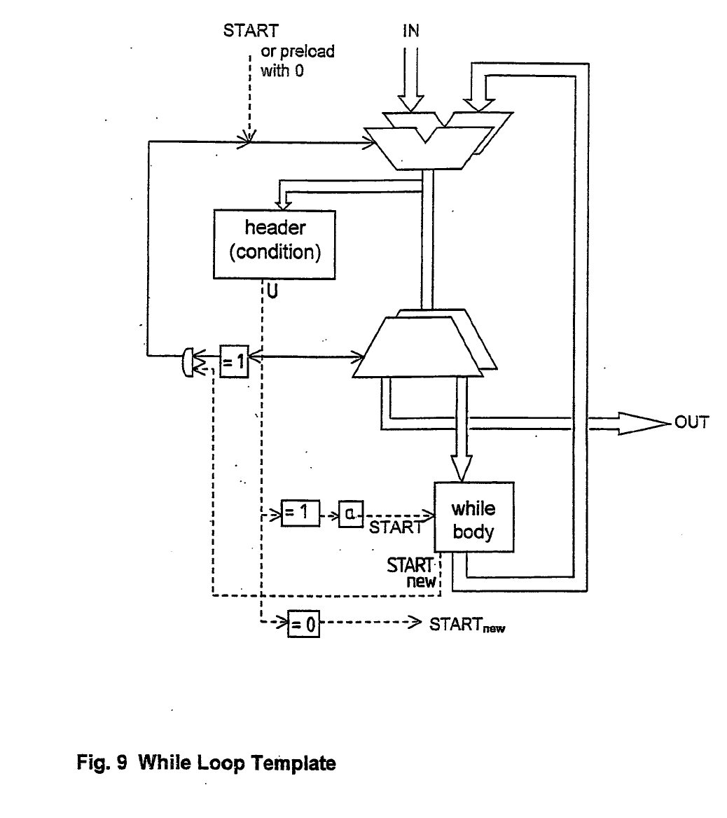

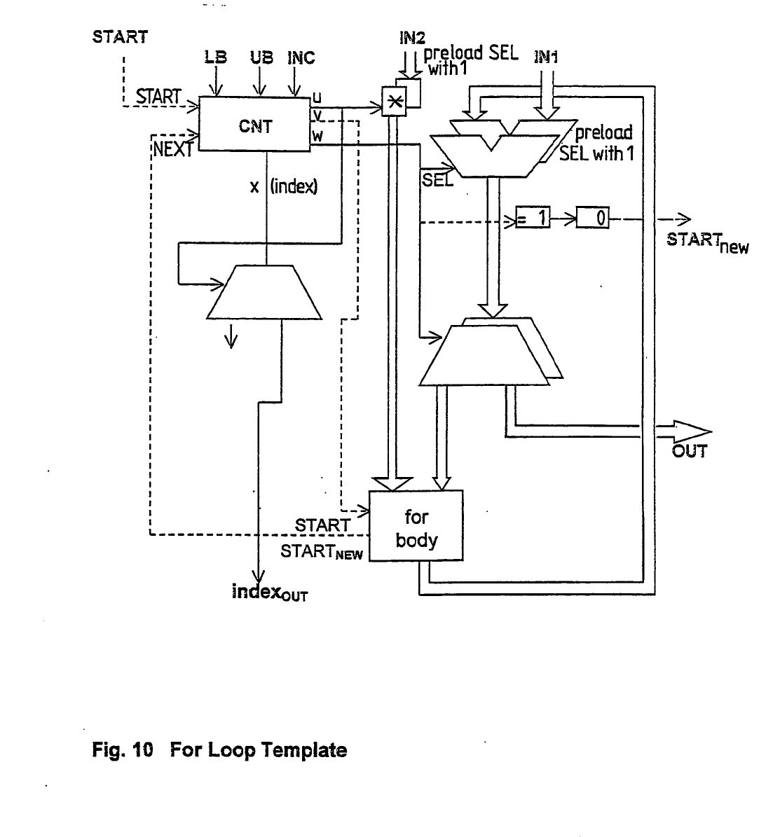

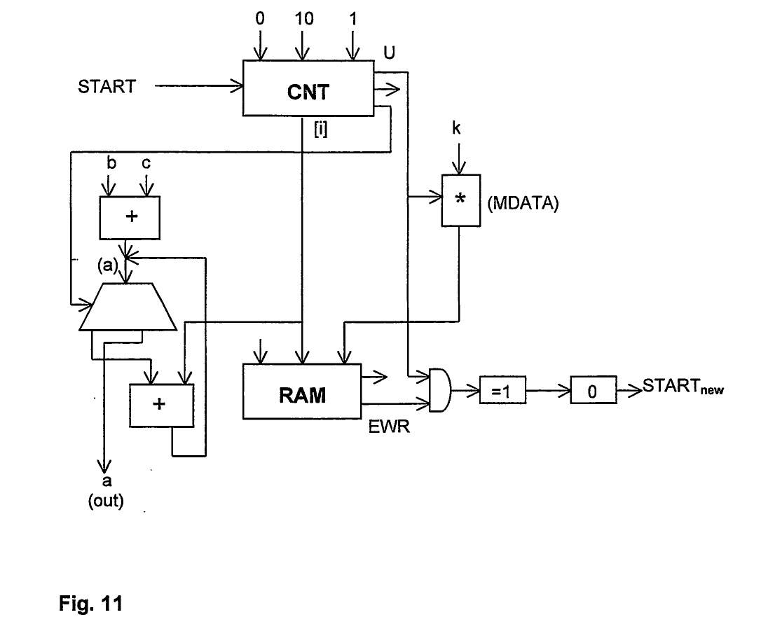

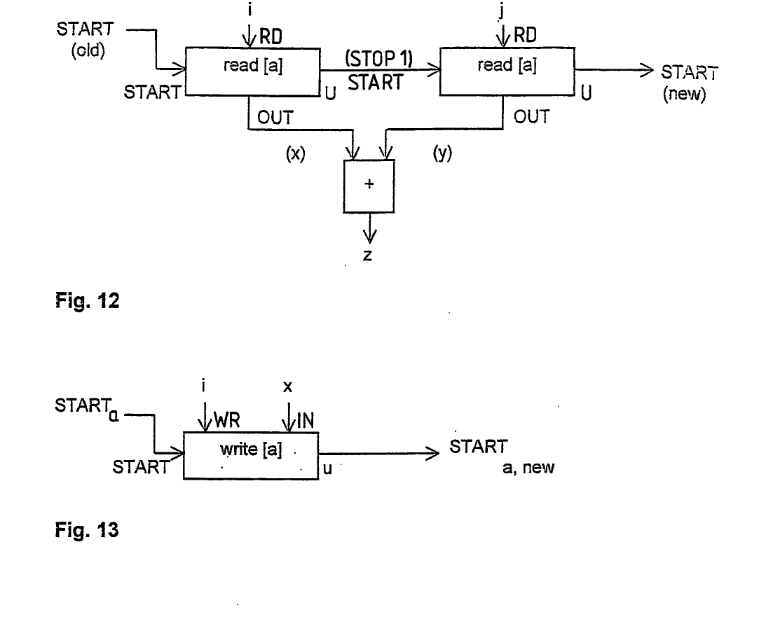

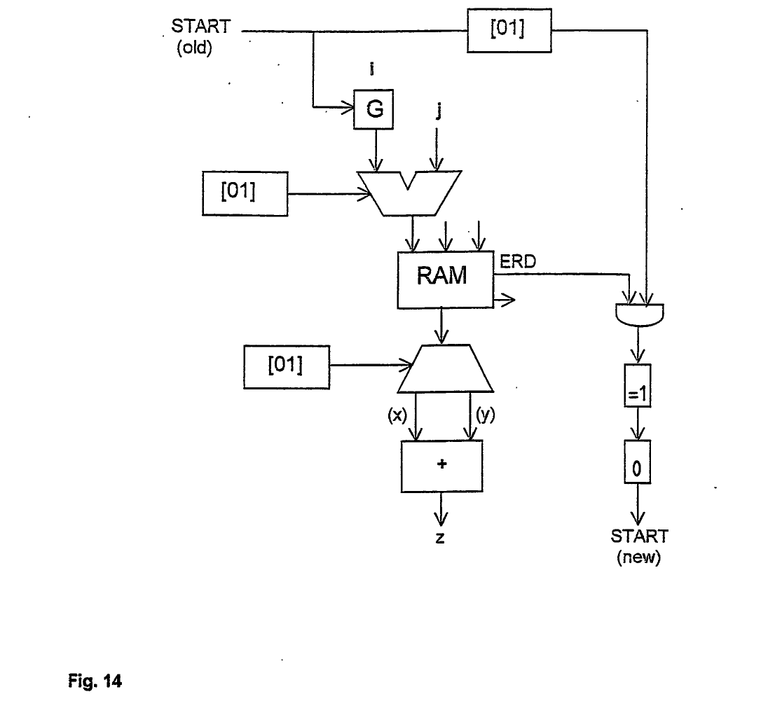

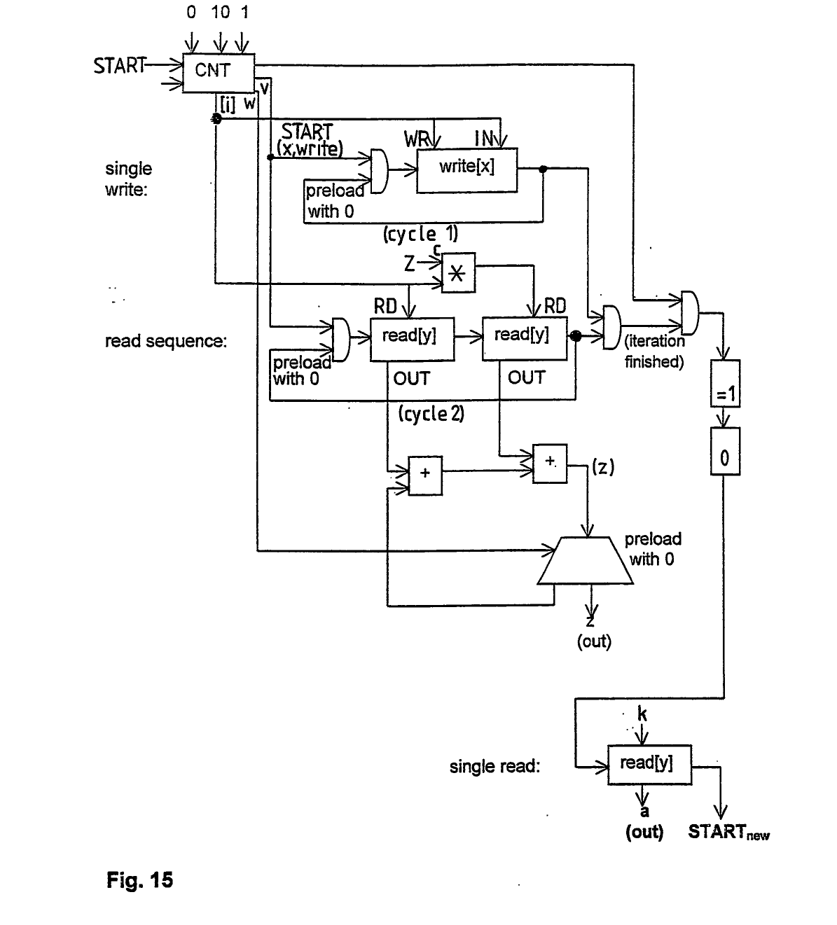

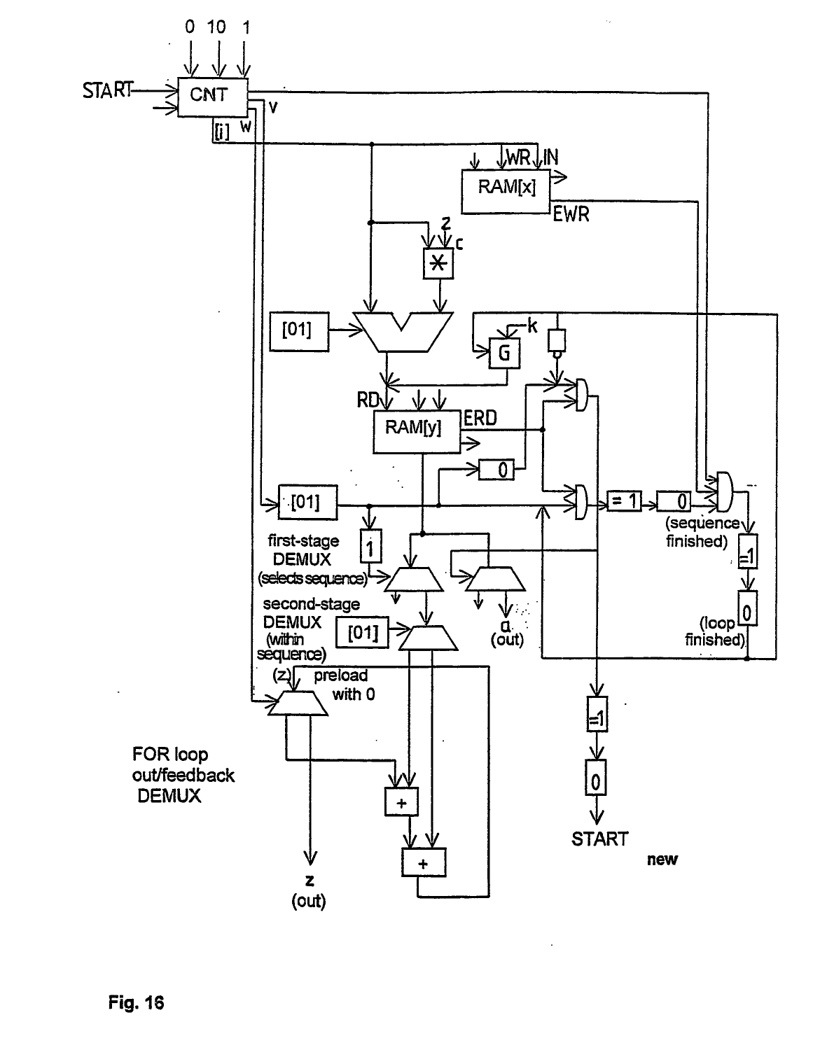

The present invention relates to the subject matter claimed and hence refers to a method and a device for compiling programs for a reconfigurable device.

Reconfigurable devices are well-known. They include systolic arrays, neuronal networks, Multiprocessor systems, Prozessoren comprising a plurality of ALU and/or logic cells, crossbar-switches, as well as FPGAs, DPGAs, XPUTERs, asf. Reference is being made to DE 44 16 881 A1, DE 197 81 412 A1, DE 197 81 483 A1, DE 196 54 846 A1, DE 196 54 593 A1, DE 197 04 044.6 A1, DE 198 80 129 A1, DE 198 61 088 A1, DE 199 80 312 A1, PCT/DE 00/01869, DE 100 36 627 A1, DE 100 28 397 A1, DE 101 10 530 A1, DE 101 11 014 A1, PCT/EP 00/10516, EP 01 102 674 A1, DE 198 80 128 A1, DE 101 39 170 A1, DE 198 09 640 A1, DE 199 26 538.0 A1, DE 100 050 442 A1 the full disclosure of which is incorporated herein for purposes of reference.

Furthermore, reference is being made to devices and methods as known from U.S. Pat. No. 6,311,200; U.S. Pat. No. 6,298,472; U.S. Pat. No. 6,288,566; U.S. Pat. No. 6,282,627; U.S. Pat. No. 6,243,808 issued to Chameleonsystems INC, USA noting that the disclosure of the present application is pertinent in at least some aspects to some of the devices disclosed therein.

The invention will now be described by the following papers which are part of the present application.

1. Introduction

This document describes the PACT Vectorising C Compiler XPP-VC which maps a C subset extended by port access functions to PACT's Native Mapping Language NML. A future extension of this compiler for a host-XPP hybrid system is described in Section 7.3.

XPP-VC uses the public domain SUIF compiler system. For installation instructions on both SUIF and XPP-VC, refer to the separately available installation notes.

2. General Approach

The XPP-VC implementation is based on the public domain SUIF compiler framework (cf. http://suif.stanford.edu). SUIF was chosen because it is easily extensible.

SUIF was extended with two passes: partition and nmlgen. The first pass, partition, tests if the program complies with the restrictions of the compiler (cf. Section 3.1) and performs a dependence analysis. It determines if a FOR-loop can be vectorized and annotates the syntax tree accordingly. In XPP-VC, vectorization means that loop iterations are overlapped and executed in a pipelined, parallel fashion. This technique is based on the Pipeline Vectorization method developed for reconfigurable architectures¹. partition also completely unrolls inner program FOR-loops which are annotated by the user. All innermost loops (after unrolling) which can be vectorized are selected and annotated for pipeline synthesis.
¹Cf. M. Weinhardt and W. Luk: Pipeline Vectorization, IEEE Transactions on Computer-Aided Design of Integrated Circuits and Systems, February 2001, pp. 234-248.

nmlgen generates a control/dataflow graph for the program as follows. First, program data is allocated on the XPP Core. By default, nmlgen maps each program array to internal RAM blocks while scalar variables are stored in registers within the PAEs. If instructed by a pragma directive (cf. Section 3.2.2), arrays are mapped to external RAM. If it is large enough, an external RAM can hold several arrays.

Next, one ALU is allocated for each operator in the program (after loop unrolling, if applicable). The ALUs are connected according to the data-flow of the program. This data-driven execution of the operators automatically yields some instruction-level parallelism within a basic block of the program, but the basic blocks are normally executed in their original, sequential order, controlled by event signals. However, for generating more efficient XPP Core configurations, nmlgen generates pipelined operator networks for inner program loops which have been annotated for vectorization by partition. In other words, subsequent loop iterations are stated before previous iterations have finished. Data packets flow continuously through the operator pipelines. By applying pipeline balancing techniques, maximum throughput is achieved. For many programs, additional performance gains are achieved by the complete loop unrolling transformation. Though unrolled loops require more XPP resources because individual PAEs are allocated for each loop iteration, they yield more parallelism and better exploitation of the XPP Core.

Finally, nmlgen outputs a self-contained NML file containing a module which implements the program on an XPP Core. The XPP IP parameters for the generated NML file are read from a configuration file, cf. Section 4. Thus the parameters can be easily changed. Obviously, large programs may produce NML files which cannot be placed and routed on a given XPP Core. Later XPP-VC releases will perform a temporal partitioning of C programs in order to overcome this limitation, cf. Section 7.1.

3. Language Coverage

This Section describes which C files can currently be handled by XPP-VC.

3.1 Restrictions

3.1.1 XPP Restrictions

The following C language operations cannot be mapped to an XPP Core at all. They are not allowed in XPP-VC programs and need to be mapped to the host processor in a codesign compiler; cf. Section 7.3,
Operating System calls, including I/O
Division, modulo, non-constant shift and floating point operations (unless XPP Core's ALU supports them)²
   ²In future XPP-VC releases, an alternative, sequential implementation of these operations by NML macros will be available.
The size of arrays mapped to internal RAMs is limited by the number and size of internal RAM blocks.
   3.1.2 XPP-VC Compiler Restrictions

The current XPP-VC implementation necessitates the following restrictions:
1. No multi-dimensional constant arrays (due to the SUIF version currently used)
2. No switch/case statements
3. No struct datatypes
4. No function calls except the XPP port and pragma functions defined in Section 3.2.1. The program must only have one function (main).
5. No pointer operations
6. No library calls or recursive calls
7. No irregular control flow (break, continue, goto, label)

Additionally, there are currently some implementation-dependent restrictions for vectorized loops, cf. the Release Notes. The compiler produces an explanatory message if an inner loop cannot be pipelined despite the absence of dependencies. However, for many of these cases, simple workarounds by minor program changes are available. Furthermore, programs which are too large for one configuration cannot be handled. They should be split into several configurations and sequenced onto the XPP Core, using NML's reconfiguration commands. This will be performed automatically in later releases by temporal partitioning, cf. Section 7.1.

3.2 XPP-VC C Language Extensions

We now describe useful C language extensions used by XPP-VC. In order to use these extensions, the C program must contain the following line:

#include “XPP.h”

This header file, XPP.h, defines the port functions defined below as well as the pragma function xpp_unroll( ). If XPP_unroll( ) directly precedes a FOR loop, it will be completely unrolled by partition, cf. Section 6.2.

3.2.1 XPP Port Functions

Since the normal C I/O functions cannot be used on an XPP Core, a method to access the XPP I/O units in port mode is provided. XPP.h contains the definition of the following two functions:

XPP_getstream(int ionum, int portnum, int *value)
XPP_putstream(int ionum, int portnum, int value)

ionum refers to an I/O unit (1.4), and portnum to the port used in this I/O unit (0 or 1). For the duration of the execution of a program, an I/O unit may only be used either for port accesses or for RAM accesses (see below). If an I/O unit is used in port mode, each portnum can only be used either for read or for write accesses during the entire program execution. In the access functions, value is the data received from or written to the stream. Note that XPP_getstream can currently only read values into scalar variables (not directly into array elements!), whereas XPP_putstream can handle any expressions. An example program using these functions is presented in Section 6.1.
3.2.2 pragma Directives

Arrays can be allocated to external memory by a compiler directive:

#pragma extern <var> <RAM_number>

Example: #pragma extern×1 maps array×to external memory bank 1.

Note the following:
<var>must be defined before it is used in the pragma.
Bank <RAM_number> must be declared in the file xppvc_options, cf. Section 4.
If two arrays are allocated to the same external RAM bank, they are arranged in the order of appearance of their respective pragma directives. The resulting offsets are recorded in file.itf, cf. Section 5.1.
   4. Directories and Files

After correct installation, the XPPC_ROOT environment variable is defined, and the PATH variable extended. $XPPC_ROOT is the XPP-VC root directory. $XPPC_ROOT/bin contains all binary files and the scripts xppvcmake and xppgcc. $XPPC_ROOT/doc contains this manual and the file xppvc_releasenotes.txt. XPP.h is located in the include subdirectory.

Finally, $XPPC_ROOT/lib contains the options file xppvc_options. If an options file with the same name exist in the current working directory or the xds subdirectory of the user's home directory, they are used (in this order) instead of the master file in $XPPC_ROOT/lib.

TABLE 1
Options

| | | Default value in |
|---|---|---|
| Option | Explanation | Xppvc_options |
| debug | debug output enabled | on |
| version | XPP IP version | V2 |
| pacsize | number of ALU-PAEs in x and y | 6/12 |
| | direction | |
| xppsize | number of PACs in x and y | 1/1 |
| | direction | |
| busnumber | number of data and event buses per | 6/6 |
| | row (both dir.s) | |
| iramsize | number of words in one internal | 256 |
| | RAM | |
| bitwidth | XPP data bid width | 32 |
| freg_data_port | number of FREG data ports | 3 |
| breg_data_port | number of BREG data ports | 3 |
| freg_event_port | number of FREG event ports | 4 |
| breg_event_port | number of BREG event ports | 4 |

xppvc_options sets the compiler options listed in Table 1. Most of them define the XPP IP parameters which are used in the generated NML file. Lines starting with a # character are comment lines.

Additionally, extram followed by four integers declares the external RAM banks used for storing arrays. At most four external RAMs can be used. Each integer represents the size of the bank declared. Size zero must be used for banks which do not exist. The master file contains the following line which declares four 4GB (1 G words) external banks:

extram 1073741824 1073741824 1073741824 1073741824

Note that, in order to simplify programming, xppvc_options does not have to be changed if an I/O unit is used for port accesses. However, this memory bank is not available in this case despite being declared.

5. Using XPP-VC

5.1 xppvcmake

In order to create an NML file, file.c is compiled with the command xppvcmake file.nml.xppvcmake file.xbin additionally calls xmap. With xppvcmake, XPP.h is automatically searched for in directory $XPPC_ROOT/include.

The following output produced by translating the example program streamfir.c in Section 6.1 shows the programs called by xppvcmake:

```
$ xppvcmake streamfir.nml
pscc -I/home/wema/xppc/include -parallel
-no PORKY_FORWARD_PROP4
  -.spr streamfir.c
porky -dead-code streamfir.spr streamfir.spr2
partition streamfir.spr2 streamfir. svo
Program analysis:
  main: DO-LOOP, line 9 can be synthesized
  main: can be synthesized completely
Program partitioning:
  Entire program selected for XPU module synthesis.
  main: DO-LOOP, line 9 selected for synthesis
porky -const-prop -scalarise -copy-prop -dead-code streamfir.svo
  streamfir.svo1
predep -normalize streamfir.svo1 streamfir.svo2
porky -ivar -know-bounds -fold streamfir.svo2 streamfir.sur
nmlgen streamfir.sur streamfir.xco
```

pscc is the SUIF frontend which translates steamfir.c into the SUIF intermediate representation, and porky performs some standard optimizations. Next, partition analyses the program. The output indicates that the entire program can and will be mapped to NML. Then porky and predep perform some additional optimizations before nmlgen actually generates the file streamfr.nml. The SUIF file streamfir.xco is generated to inspect and debug the result of code transformations.³ In the generated NML file, only the I/O ports are placed. All other objects are placed automatically by xmap. Cf. Section 6.1 for an example of the xsim program using the I/O ports corresponding to the stream functions used in the program.
³In an extended codesign compiler, the .xco file would also be used to generate the host partition of the program.

For an input file file.c, nmlgen also creates an interface description file file.iff in the working directory. It shows the array to RAM mapping chosen by the compiler. In the debug subdirectory (which is created), files file.part dbg and file.nmlgen_dbg are generated. They contain more detailed debugging information created by partition and nmlgen respectively. The files file_first.dot and file_final dot created in the debug directory can be viewed with the dotty graph layout tool. They contain graphical representations of the original and the transformed and optimized version of the generated control/dataflow graph.

5.2 xppgcc

This command is provided for comparing simulation results obtained with xppvcmake, xmap and xsim (or from execution on actual XPP hardware) with a “direct” compilation of the C program with gcc on the host. xppgcc compiles the input program with gcc and binds it with predefined XPP_getstream and XPP_putstream functions. They read or write files port<n>_<m>.dat in the current directory for n in 1 . . . 4 and m in 0 . . . 1. For instance, the program in Section 6.1 is compiled as follows:

xppgcc -o streamfir streamfir.c

The resulting program streamfir will read input data from port1_{—}0.dat and write its results to port4_{—}0.dat⁴.
⁴However, programs receiving initial data from or writing result data to external RAMs in xsim cannot be compared to directly compiled programs using xppgcc. The results may also differ if a bitwidth other than 32 is used for the generated NML files.

### 6. EXAMPLES

6.1 Stream Access

The following program streamfir.c is a small example showing the usage of the XPP_getstream and XPP_putstream functions. The infinite WHILE-loop implements a small FIR filter which reads input values from port I_{—}0and writes output values to port 4_{—}0. The variables xd, xdd and xddd are used to store delayed input values. The compiler automatically generates a shift-register-like configuration for these variables. Since no operator dependencies exist in the loop, the loop iterations overlap automatically, leading to a pipelined FIR filter execution.

| | |
|---|---|
| 1 | #include “XPP.h” |
| 2 | |
| 3 | main( ) { |
| 4 | int x, xd, xdd, xddd; |
| 5 | |
| 6 | x = 0; |
| 7 | xd = 0; |
| 8 | xdd = 0; |
| 9 | while (1) { |
| 10 | xddd = xdd; |
| 11 | xdd = xd; |
| 12 | xd = x; |
| 13 | XPP_getstream(1, 0, &x); |
| 14 | XPP_putstream(4, 0, (2*x + 6*xd + 6*xdd + 2*xddd) >> 4); |
| 15 | } |
| 16 | } |

After generating streamfir.xbin with the command xppvcmake streamfir.xbin, the following command reads the input file port1_{—}0.dat and writes the simulation results to xpp_port4_{—}0.dat.

xsim -run 2000 -in1_0 port1_0.dat -out4_0 xpp_port4_0.dat
streamfir.xbin > /dev/null

xpp_port4_{—}0.dat can now be compared with port4_{—}0.dat generated by compiling the program with xppgcc and running it with the same port1_{—}0.dat.

6.2 Array Access

The following program arrayir.c is an FIR filter operating on arrays. The first FOR-loop reads input data from port 1_{—}0 into array x, the second loop filters x and writes the filtered data into array y, and the third loop outputs y on port 4_{—}0.

| | |
|---|---|
| 1 | #include “XPP.h” |
| 2 | #define N 256 |
| 3 | int x[N], y[N]; |
| 4 | const int c[4] = { 2, 4, 4, 2 }; |
| 5 | main( ) { |
| 6 | int i, j, tmp; |
| 7 | for (i = 0; i < N; i++) { |
| 8 | XPP_getstream(1, 0, &tmp); |
| 9 | x[i] = tmp; |
| 10 | } |
| 11 | for (i = 0; i < N−3; i++) { |
| 12 | tmp = 0; |
| 13 | XPP_unroll( ); |
| 14 | for (j = 0; j < 4; j++) { |
| 15 | tmp += c[j]*x[i+3−j]; |
| 16 | } |
| 17 | y[i+2] = tmp; |
| 18 | } |
| 19 | for (i = 0; i < N−3; i++) |
| 20 | XPP_putstream(4, 0, y[i+2]); |
| 21 | } |

xppvcmake produces the following output:

```
$ xppvcmake arrayfir.nml
pscc -I/home/wema/xppc/include -parallel
no PORKY_FORWARD_PROP4
  -.spr arrayfir.c
porky -dead-code arrayfir.spr arrayfir.spr2
partition arrayfir.spr2 arrayfir.svo
Program analysis:
  main: FOR-LOOP i, line 7 can be synthesized/vectorized
  main: FOR-LOOP j, line 14 can be synthesized/unrolled/vectorized
  main: FOR-LOOP i, line 11 can be synthesized/vectorized
  main: FOR-LOOP i, line 19 can be synthesized/vectorized
  main: can be synthesized completely
Program partitioning:
  Entire program selected for NML module synthesis.
  main: FOR-LOOP i, line 7 selected for pipeline synthesis
  main: FOR-LOOP i, line 11 selected for pipeline synthesis
  main: FOR-LOOP i, line 19 selected for pipeline synthesis
    ...unrolling loop j
porky -const-prop -scalarise -copy-prop -dead-code arrayfir.svo
arrayfir.svo1
predep -normalize arrayfir.svo1 arrayfir.svo2
porky -ivar -know-bounds -fold arrayfir.svo2 arrayfir.sur
nmlgen arrayfir.sur arrayfir.xco
```

The messages from partition show that all loops can be vectorized. The dependence analysis did not find any loop-carried dependencies preventing vectorization. The inner loop in the middle of the program is unrolled. The outer loop's body is effectively substituted by the following statement:

y[i+2] = c[0]*x[i+3] + c[1]*x[i+2] + c[2]*x[i+1] + c[3]*x[i];

Since all remaining loops are innermost loops, they are selected for pipeline synthesis. Array reads, computations, and array writes overlap. To reduce the number of array accesses, the compiler automatically removes redundant array reads. In the middle loop, only x[i+3] is read. For x[i+2], x[i+1] and x[i], delayed versions of x[i+3] are used, forming a shift-register. Therefore, each loop iteration needs only one cycle since one read from x, all computations, and one write to y can be executed concurrently.

Finally, the following example program fragment is a 2-D edge detection algorithm.

| /* 3x3 horiz. + vert. edge detection in both directions */ | |
|---|---|
| for(v=0; v<=VERLEN−3; v++) { | |
| for(h=0; h<=HORLEN−3; h++) { | |
| htmp = | (p1[v+2][h] − p1[v][h]) + |
| | (p1[v+2][h+2] − p1[v][h+2]) + |
| | 2 * (P1 [v+2][h+1] − p1[v][h+1]); |
| if (htmp < 0) | |
| htmp = − htmp; | |
| vtmp = | (p1[v][h+2] − p1[v][h]) + |
| | (p1[v+2](h+2] − p1[v+2][h]) + |
| | 2 * (p1 [v+1] [h+2] − p1[v+1] [h]); |

```
    if (vtmp < 0)
      vtmp = − vtmp;
    sum = htmp + vtmp;
    if (sum > 255)
      sum = 255;
    p2[v+1][h+1] = sum;
  }
}
```

As the output of partition shows, both loops can be vectorized. Since only innermost loops can be pipelined, the outer loop is executed sequentially. (Note that the line numbers in the program outputs are not obvious since only a program fragment is shown above.)

```
partition edge.spr2 edge.svo
Program analysis:
  main: FOR-LOOP h, line 22 can be synthesized/can be vectorized
  main: FOR-LOOP v, line 21 can be synthesized/can be vectorized
  main: can be synthesized completely
Program partitioning:
  Entire program selected for XPP module synthesis.
  main: FOR-LOOP h, line 22 selected for pipeline synthesis
  main: FOR-LOOP v, line 21 selected for synthesis
```

Also note the following additional features of this program: Address generators for the 2-D array accesses are automatically generated, and the array accesses are reduced by generating shift-registers for each of the three image lines accessed. Furthermore, the conditional statements are implemented using SWAP (MUX) operators. Thus the streaming of the pipeline is not affected by which branch the conditional statements take.

7. Future Compiler Extensions

Apart from removing some of the restrictions of Section 3.1.2, the following extensions are planned for XPP-VC.

7.1 Temporal Partitioning

By using the pragma function XPP_next.conf( ), programs are partitioned into several configurations which are loaded and executed sequentially on the XPP Core. Specific NML configuration commands are generated which also exploit XPP's sophisticated configuration and preloading capabilities. Eventually, the temporal partitions will be determined automatically.

7.2 Program Transformations

For more efficient XPP configuration generation, some program transformations are useful. In addition to loop unrolling, loop merging, loop distribution and loop tiling will be used to improve loop handling, i.e. enable more parallelism or better XPP usage.

Furthermore, programs containing more than one function could be handled by inlining function calls.

7.3 Codesign Compiler

This section sketches what an extended C compiler for an architecture consisting of an XPP Core combined with a host processor might look like. The compiler should map suitable program parts, especially inner loops, to the XPP Core, and the rest of the program to the host processor. I. e., it is a host/XPP codesign compiler, and the XPP Core acts as a coprocessor to the host processor.

This compiler's input language is full standard ANSI C. The user uses pragmas to annotate those program parts that should be executed by the XPP Core (manual partitioning). The compiler checks if the selected parts can be implemented on the XPP. Program parts containing non-mappable operations must be executed by the host.

The program parts running on the host processor (“SW”), and the parts running on the PAE array (“XPP”) cooperate using predefined routines (copy_data_to_XPP, copy_data_to_host, start_config(n), wait_for_coprocessor_finish(n), request_config(n)). For all XPP program parts, XPP configurations are generated. In the program code, the XPP part n is replaced by request config(n), start config(n), wait for coprocessor finish(n), and the necessary data movements. Since the SUIF compiler contains a C backend, the altered program (host parts with coprocessor calls) can simply be written back to a C file and then processed by the native C compiler of the host processor.

Thus the sequential control flow of the C program defines when XPP parts are configured into the XPP Core and executed.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method for partitioning large computer programs and or algorithms at least part of which is to be executed by an array of reconfigurable units such as ALUS,
comprising the steps of
defining a maximum allowable size to be mapped onto the array, partitioning the program such that its separate parts minimize the overall execution time and providing a mapping onto the array not exceeding the maximum allowable size.

2. A device for partitioning large computer programs and or algorithms at least part of which is to be executed by an array of reconfigurable units such as ALUS,
comprising
means for defining a maximum allowable size to be mapped onto the array, means for partitioning the program such that its separate parts minimize the overall execution time and for providing a mapping onto the array not exceeding the maximum allowable size.
